(19) United States
(12) Patent Application Publication
(10) Pub. No.: US 2010/0272630 A1
(43) Pub. Date: Oct. 28, 2010

(54) SYSTEM AND PROCESS FOR CONVERTING NON-FRESH WATER TO FRESH WATER

(75) Inventor: Itzhak Rosenbaum, Markham (CA)

Correspondence Address: STIKEMAN ELLIOTT LLP, 1600-50 O''CONNOR STREET, OTTAWA, ON, K1P 6L2, CA

(73) Assignee: HTE WATER CORPORATION, Markham (CA)

(21) Appl. No.: 12/572,832

(22) Filed: Oct. 2, 2009

Related U.S. Application Data
(63) Continuation-in-part of application No. 12/428,153, filed on Apr. 22, 2009.

(51) Int. Cl. C01B 5/00; F01K 17/00; B01J 19/08; C02F 1/02; C25B 9/00

(52) U.S. Cl. 423/580.1; 60/648; 422/186.04; 210/175; 204/242

(57) ABSTRACT

A method of converting non-fresh water to fresh water, referred to as the “Rosenbaum-Weisz Process”, is disclosed. The Process utilizes high temperature electrolysis to decompose the treated non-fresh water into hydrogen and oxygen. The generated hydrogen and oxygen are then combusted at elevated pressure in a high temperature combustor to generate high pressure high temperature superheated steam. The combustion of hydrogen and oxygen at elevated high pressure will prevent air from entering the combustor thereby preventing the creation of nitrous oxide (“NOX”) that might otherwise be created as a result of the high temperature created by the combustion. The heat from the high pressure high temperature superheated steam is then removed by a high temperature heat exchanger system and recycled back to the high temperature electrolysis unit. The superheated steam will condense, as a result of the heat extraction by the heat exchanger system, to produce fresh water.

### CROSS REFERENCE TO RELATED APPLICATIONS

This application is a continuation-in-part of U.S. patent application Ser. No. 12/482,153 filed Apr. 22, 2009.

### FIELD OF THE INVENTION

The present invention relates to the conversion of non-fresh water to fresh water.

### BACKGROUND

Water is one of the most vital natural resources for all life on Earth. The availability and quality of water has always played an important part in determining not only where people can live, but also their quality of life. Domestic use includes water that is used in the home every day such as for drinking, food preparation, bathing, washing clothes and dishes, flushing toilets, and watering lawns and gardens. Commercial water use includes fresh water for motels, hotels, restaurants, office buildings, other commercial facilities, and civilian and military institutions. Industrial water use is a valuable resource to a nation's industries for such purposes as processing, cleaning, transportation, dilution, and cooling in manufacturing facilities. Major water-using industries include steel, chemical, paper, and petroleum refining. Water is used in the production of electricity in thermoelectric power plants that are fueled by fossil fuels, nuclear fission, or geothermal. Irrigation water use is water artificially applied to farm, orchard, pasture, and horticultural crops, as well as water used to irrigate pastures, for frost and freeze protection, chemical application, crop cooling, and harvesting. Livestock water use includes water for stock animals, feed lots, dairies, fish farms, and other nonfarm needs. Water is needed for the production of red meat, poultry, eggs, milk, and wool, and for horses, rabbits, and pets.

The planet's water reserves are estimated at 1,304,100 teratons (1 teraton is 10¹² tons) of which freshwater reserves only account for 2.82% of this figure. Agriculture consumes 70% of the world's freshwater, industry 20% and households 10%. Between 1900 and 1995, drinking water demand grew twice as fast as the world population. By 2025, this demand should grow another 40%. In fifty years, the Canadian Agency for International Development has predicted that some forty countries could lack adequate drinking water. This will inevitably lead to conflict, even wars, as local areas, provinces and countries will go to any length to defend their fresh water resources.

Almost all conventional power plants, including coal, oil, natural gas, and nuclear facilities, employ water cycles in the generation of electricity. Recently available data from the U.S. Geologic Survey shows that thermoelectric power plants, in the U.S.A., use more than 195 billion gallons of water per day. Such immense water needs produce equally immense concerns given the likelihood of future droughts and shortages, especially during the summer months. The addition of new conventional power plants therefore, has inherent water-related risks that may result in electric utilities no longer able to construct them.

In Canada, there are vast oil sand resources estimate at 1.7 trillion barrels (270×10⁹ m³) of bitumen. Water is required to convert bitumen into synthetic crude oil. A recent report by the Pembina Institute shows that it requires about 2-4.5 m³ of water to produce one cubic metre (m³) of synthetic crude. The need for industrial water use will increase with population growth and global warming as the demand for fuel and electricity increases.

According to recent numbers by UNICEF and the World Health Organization, there are an estimated 884 million people without adequate drinking water, and a correlating 2.5 billion without adequate water for sanitation (e.g. wastewater disposal). Also, cross-contamination of drinking water by untreated sewage is the chief adverse outcome of inadequate safe water supply. Consequently, disease and significant deaths arise from people using contaminated water supplies; these effects are particularly pronounced for children in underdeveloped countries, where 3900 children per day die of diarrhea alone. The greatest irony is that 97% of the water exists as seawater which is unfit for human consumption. Consequently, as the world population grows it is increasingly important to find ways to produce fresh water such as by converting non-fresh water and in particular seawater, waste water, brackish water and polluted waters to fresh water. “Fresh water” as used herein is potable water.

Seawater contains about 3% salts and minerals, with 97% of the seawater being water. Brackish water contains more than 500 ppm of salts but less than sea water, which has between 34,000 to 36,000 ppm of salt. Desalination refers to any of several processes that convert seawater to fresh water. Sometimes the process produces table salt as a by-product. It is also used on many seagoing ships and submarines.

### DESCRIPTION OF PRIOR ART

The two most popular desalination technologies are Multi Stage Flash Distillation (MSF) and Reverse Osmosis (RO), or some variations of them, which account for about 90% of the technologies that desalinate seawater across the globe. Most desalination plants convert only about 30%-60% of the seawater to fresh water.

Multi-stage flash distillation (“MSF”) is a desalination process that distills sea water by flashing a portion of the water into steam in multiple stages of what are essentially regenerative heat exchangers. Seawater is first heated in a container known as a brine heater. This is usually achieved by condensing steam on a bank of tubes carrying sea water through the brine heater. Heated water is passed to another container known as a “stage”, where the surrounding pressure is lower than that in the brine heater. It is the sudden introduction of this water into a lower pressure “stage” that causes it to boil so rapidly as to flash into steam. As a rule, only a small percentage of this water is converted into steam. Consequently, it is normally the case that the remaining water will be sent through a series of additional stages, each possessing a lower ambient pressure than the previous “stage.” As steam is generated, it is condensed on tubes of heat exchangers that run through each stage. MSF distillation plants, especially large ones, are paired with power plants in a cogeneration configuration where the waste heat from the power plant is used to heat the seawater rather than generate electricity or be used in an industrial/chemical process. The power plants consume large amounts of fossil fuels thereby contributing significantly to global warming. The world's largest MSF desalination plant is the Jebel Ali Desalination Plant located in the United Arab Emirates and is capable of producing 820,000 cubic meters (215 million gallons/day) of fresh water per day.

Reverse Osmosis (“RO”) is a filtration process typically used for water. It works by using pressure to force a solution through a membrane, retaining the solute on one side and allowing the pure solvent to pass to the other side. This is the reverse of the normal osmosis process, which is the natural movement of solvent from an area of low solute concentration, through a membrane, to an area of high solute concentration when no external pressure is applied. The largest Sea Water Reverse Osmosis (SWRO) installation is built in Ashkelon, Israel capable of producing 320,000 cubic meters of fresh water per day. The Ashkelon plant has a dedicated 80 MW gas turbine to supply the required electrical need. The Tampa Bay plant (the largest in North America) takes 44 million gallons of seawater and converts it to 25 million gallons (95,000 cubic meters) of fresh water every day (a 56.8% conversion rate).

Electrolysis of water is the decomposition of water (H₂O) into oxygen (O₂) gas and hydrogen (H₂) gas due to an electric current being passed through the water. An electrical power source is connected to two electrodes, or two plates, (typically made from some inert metal such as platinum or stainless steel) which are placed in the water. Hydrogen will appear at the cathode (the negatively charged electrode, where electrons are pumped into the water), and oxygen will appear at the anode (the positively charged electrode). The generated amount of hydrogen is twice the amount of oxygen, and both are proportional to the total electrical charge that was sent through the water. Electrolysis of pure water is very slow, and can only occur due to the self-ionization of water. Pure water has an electrical conductivity about one millionth that of seawater. It is sped up dramatically by adding an electrolyte (such as a salt, an acid or a base). Electrolysis at normal conditions (25° C. and 1 atm) is completely impractical for electrolyzing water for anything but a small lab experiment.

High-temperature electrolysis (“HTE”), also known as steam electrolysis, is the same concept as electrolysis except that it occurs at high temperatures. High temperature electrolysis is more efficient economically than traditional room-temperature electrolysis because some of the energy is supplied as heat, which commercially is generally less expensive to supply than electricity, and because the electrolysis reaction is more efficient at higher temperatures.

As we go to higher temperatures, the energy necessary for electrolysis comes from heat (thermal energy) rather than electricity. It is known that at around 1000° C., about 70% of the energy requirement comes from electricity and about 30% can come from heat. This increases the efficiency and reduces the cost significantly.

Thermal decomposition, also called thermolysis, is defined as a chemical reaction when a chemical substance breaks up into at least two chemical substances when heated. The reaction is usually endothermic as heat is required to break chemical bonds in the compound undergoing decomposition. The decomposition temperature of a substance is the temperature at which the substance decomposes into smaller substances or into its constituent atoms. As explained previously, water will decompose to its elements at temperatures around 3200° C. at 1 atm. In this case the entire required energy for hydrogen and oxygen production is completely provided by heat and no electricity is necessary.

As discussed above, fresh water scarcity is a growing problem in many parts of the world. However, in parts of the world where fresh water is more abundant, the fresh water supply can also be threatened, not by scarcity, but rather by contamination. For example, an investigation by the Associated Press has revealed that the drinking water of at least 41 million people in the United States is contaminated with pharmaceutical drugs. It has long been known that drugs are not wholly absorbed or broken down by the human body. Significant amounts of any medication taken eventually pass out of the body, primarily through the urine. While sewage is treated before being released back into the environment and water from reservoirs or rivers is also treated before being funneled back into the drinking water supply, none of these treatments are able to remove all traces of medications.

Medications for animals are also contaminating the water supply. Drugs given to animals are also entering the water supply. One study found that 10 percent of the steroids given to cattle pass directly through their bodies. Another study found that steroid concentrations in the water downstream of a Nebraska feedlot were four times as high as the water upstream. Male fish downstream of the feedlot were found to have depressed levels of testosterone and smaller than normal heads, most likely due to the pharmaceutical contamination in their water.

In most modern cities, rivers and lakes, within their vicinity have become the focal point of business, resulting in heavy development and commercialization of these primary natural resources. The Seine River in Paris, the Singapore River in the Lion City, the Chao Phraya in Bangkok and the Thames in London, to name just a few famous ones, have all been turned into tourist destinations with massive commercial development around them. In all these cities, businesses flourish along their river corridors and the aesthetic values the rivers offer to the city denizens such as scenic beauty, solitude, natural environment cannot be described with words but need to be experienced. But, there is a heavy price to pay for the massive economic development and the booming commercial activities along these rivers and within their vicinity. These rivers are slowly being killed by the unrestrained development which is often accompanied by massive pollution and other ecological damage.

Conventional desalination methods (most notably Multi-Stage Flashing and Reverse Osmosis) can help to close the gap between the supply and demand of fresh water. However, these desalination methods require a lot of capital expenditures and consume an enormous amount of fossil fuels. The sad reality is that the countries that need the fresh water most are the developing countries (and in many cases the poorest countries) who do not have the required capital and can not afford to purchase the enormous annual amount of fossil fuel that is required to operate these plants.

In the last decade, there has been much discussion about using nuclear energy to provide the required energy for the desalination plants. While nuclear plants may offer some solutions, they also create many other problems. Nuclear plants require significant capital, take a long time to be put in place (permitting, construction etc.) and require the availability of highly trained staff to run the plants. Unfortunately, this option will not be available to most developing countries and in particular the poorest countries. In the world of instability, the last thing that the world need is the proliferation of nuclear plants that may lead to a nuclear race in many unstable regions of the world. Moreover, it is impractical to have a nuclear plant in every province much less in every village where fresh water is often needed most.

Produced water is a term used in the oil and gas industry to describe water that is produced along with oil and gas obtained from a well. To achieve increased oil recovery additional water is often injected into the reservoirs to help force the oil to the surface. Both the formation water and the injected water are eventually produced along with the oil and therefore as the field becomes depleted the produced water content of the oil increases. Produced water is often used as an injection fluid. This reduces the potential of causing formation damage due to incompatible fluids, although the risk of scaling or corrosion in injection flowlines or tubing remains. Also, the produced water, being contaminated with hydrocarbons and solids, must be disposed of in some manner, and disposal to sea or river requires a certain level of clean-up of the water stream first. However, the processing required to render produced water fit for reinjection may be equally costly. As the volumes of water being produced are never sufficient to replace all the production volumes (oil & gas, in addition to water), additional “make-up” water must be provided. Mixing waters from different sources exacerbates the risk of scaling. Consequently, the acquisition of fresh water and the disposal of produced water are significant cost in oil and gas production.

The technique of hydraulic fracturing is used to increase or restore the rate at which fluids, such as oil, gas or water, can be produced from the desired formation. The method is informally called fracking or hydro-fracking. By creating fractures, the reservoir surface area exposed to the borehole is increased. The fracture fluid can be any number of fluids, ranging from water to gels, foams, nitrogen, carbon dioxide or even air in some cases. The fracture, which is kept open using a proppant such as sand or ceramic beads, provides a conductive path connecting a larger area of the reservoir to the well, thereby increasing the area from which fluids can be produced from the desired formation. The produced water (called flowback water) is contaminated and must be treated prior to disposal. In many instances flowback water is trucked away to be treated elsewhere. Consequently, the acquisition of fresh water and the disposal of the flowback water are significant cost of production.

Bituminous sands (tar sands) are a major source of unconventional oil. The extra-heavy oil and bitumen flow very slowly, if at all, toward producing wells under normal reservoir conditions. The sands must be extracted by strip mining or the oil made to flow into wells by in situ techniques which reduce the viscosity by injecting steam, solvents, and/or hot air into the sands. These processes use vast amounts of fresh water and require larger amounts of energy to produce the vast amounts of steam that is used in the extraction operation. Between 2 to 4.5 volume units of water are used to produce each volume unit of synthetic crude oil. Despite recycling, almost all of the water used in the extraction ends up in tailings ponds. Consequently, the acquisition of fresh water and the disposal of produced water are a significant cost of production.

Industrial water pollution occurs across all industries. To illustrate these sources of water pollution consider the following few examples. The production of iron from ore involves powerful reduction reactions in blast furnaces. Cooling waters are inevitably contaminated with products especially ammonia and cyanide. Production of coke from coal in coking plants also requires water cooling and the use of water in by-products separation. Contamination of waste streams includes gasification products such as benzene, naphthalene, cyanide, ammonia, phenols, cresols and other chemicals. The conversion of iron or steel into sheet, wire or rods requires hot and cold mechanical transformation stages frequently employing water as a lubricant and coolant. Contaminants include hydraulic oils, tallow and particulate solids. Final treatment of iron and steel products before onward sale into manufacturing includes pickling in strong mineral acid to remove rust and prepare the surface for tin or chromium plating or for other surface treatments such as galvanizations or painting. The two acids commonly used are hydrochloric acid and sulfuric acid. Wastewaters include acidic rinse waters together with waste acid. Although many plants operate acid recovery plants, (particularly those using Hydrochloric acid), where the mineral acid is boiled away from the iron salts, there remains a large volume of highly acid ferrous sulfate or ferrous chloride to be disposed of. The principal water pollution associated with mines and quarries are slurries of rock particles in water. These arise from rainfall washing exposed surfaces and haul roads and also from rock washing and grading processes. Volumes of water can be very high, especially rainfall related arisings on large sites. Some specialized separation operations, such as coal washing to separate coal from native rock using density gradients, can produce wastewater contaminated by fine particulate hematite and surfactants. Oils and hydraulic oils are also common contaminants. Polluted water from metal mines and ore recovery plants are inevitably contaminated by the minerals present in the native rock formations. Following crushing and extraction of the desirable materials, undesirable materials may become contaminated in the wastewater. For metal mines, this can include unwanted metals such as zinc and other materials such as arsenic. Extraction of high value metals such as gold and silver may generate slimes containing very fine particles in where physical removal of contaminants becomes particularly difficult. Consequently, the acquisition of fresh water and the disposal of polluted water are a significant cost of production.

A range of industries manufacture or use complex organic chemicals. These include pesticides, pharmaceuticals, paints and dyes, petro-chemicals, detergents, plastics, paper pollution, etc. Waste waters can be contaminated by feed-stock materials, by-products, product material in soluble or particulate form, washing and cleaning agents, solvents and added value products such as plasticizers. Consequently, the acquisition of fresh water and the disposal of produced water are significant cost of production across all industries.

Oil wastes that enter the ocean come from many sources, some being accidental spills or leaks, and some being the results of chronic and careless habits in the use of oil and oil products. Most waste oil in the ocean consists of oily stormwater drainage from cities and farms, untreated waste disposal from factories and industrial facilities, and unregulated recreational boating. It is estimated that approximately 706 million gallons of waste oil enter the ocean every year, with over half coming from land drainage and waste disposal; for example, from the improper disposal of used motor oil. Offshore drilling and production operations and spills or leaks from ships or tankers typically contribute less than 8 percent of the total. The remainder comes from routine maintenance of ships (nearly 20 percent), hydrocarbon particles from onshore air pollution (about 13 percent), and natural seepage from the seafloor (over 8 percent). When oil is spilled in the ocean, it initially spreads in the water (primarily on the surface), depending on its relative density and composition. The oil slick formed may remain cohesive, or may break up in the case of rough seas. Waves, water currents, and wind force the oil slick to drift over large areas, impacting the open ocean, coastal areas, and marine and terrestrial habitats in the path of the drift. The largest accidental oil spill on record (Persian Gulf, 1991) put 240 million gallons of oil into the ocean near Kuwait and Saudi Arabia when several tankers, port facilities, and storage tanks were destroyed during war operations. The blowout of the Ixtoc/exploratory well offshore Mexico in 1979, the second largest accidental oil spill, gushed 140 million gallons of oil into the Gulf of Mexico. By comparison, the wreck of the Exxon Valdez tanker in 1989 spilled 11 million gallons of oil into Prince William Sound offshore Alaska, and ranks fifty-third on the list of oil spills involving more than 10 million gallons. Oil spills present the potential for enormous harm to deep ocean and coastal fishing and fisheries. The immediate effects of toxic and smothering oil waste may be mass mortality and contamination of fish and other food species, but long-term ecological effects may be worse. Oil waste poisons the sensitive marine and coastal organic substrate, interrupting the food chain on which fish and sea creatures depend, and on which their reproductive success is based. Commercial fishing enterprises may be affected permanently. The techniques used to clean up an oil spill depend on oil characteristics and the type of environment involved; for example, open ocean, coastal, or wetland. Pollution-control measures include containment and removal of the oil (either by skimming, filtering, or in situ combustion), dispersing it into smaller droplets to limit immediate superficial and wildlife damage, biodegradation (either natural or assisted), and normal weathering processes. Individuals of large-sized wildlife species are sometimes rescued and cleaned, but micro-sized species are usually ignored. The costs of an oil spill are both quantitative and qualitative. Quantitative costs include loss of the oil, repair of physical facilities, payment for cleaning up the spill and remediating the environment, penalties assessed by regulatory agencies, and money paid in insurance and legal claims. Qualitative costs of an oil spill include the loss of pristine habitat and communities, as well as unknown wildlife and human health effects from exposure to water and soil pollution.

### SUMMARY OF THE INVENTION

In one aspect, the present invention relates to the conversion of non-fresh water to fresh water using high temperature electrolysis to dissociate water to hydrogen and oxygen and to separate the non-water material, and then combusting the generated hydrogen and oxygen at elevated pressure to form high pressure high temperature superheated steam wherein a closed loop heat recovery system is utilized to recycle the heat generated by the combustion process to the high temperature electrolysis unit for the dissociation of the non-fresh water. The extraction of heat from the superheated steam by the heat recovery system condenses the superheated steam to produce fresh water. This total process of generating fresh water by this invention has been given the name of “The Rosenbaum-Weisz Process” by the inventor. The reference to Rosenbaum and Weisz is in honour of the inventor's parents.

In another aspect, the present invention relates to the Rosenbaum-Weisz Process which utilizes high temperature electrolysis of non-fresh water to produce fresh water. The required heat for high temperature electrolysis is obtained by capturing and utilizing heat that is generated by the combustion of hydrogen and oxygen. When hydrogen and oxygen are combusted, the resulting product is heat and superheated steam. The combustion temperature is around 3200° C. at 1 atm (same as thermolysis). The heat generated by the combustion of hydrogen and oxygen is extracted by a heat exchanger system and recycled to be used in the high temperature electrolysis process. The extraction of the heat by the heat exchanger system condenses the superheated steam into fresh water. The overall process includes the following steps: non-fresh water treatment; evaporation of the treated non-fresh water, high temperature electrolysis; hydrogen and oxygen production; hydrogen and oxygen storage; combustion of hydrogen and oxygen; heat exchanger recovery system; and the condensing of the superheated steam into fresh water.

The heat for the high temperature electrolysis can come from different sources. One way to create on-site heat is by burning fossil fuels such as natural gas to produce the required heat. Another way is to capture waste heat from a nearby cogeneration plant. The typical temperature of the waste heat from a cogeneration plant is between 800° C. and 1000° C. Yet another way is to locate a HTE facility near a nuclear plant thereby utilizing the heat from the nuclear plant. For HTE occurring at around 1500° C., the energy contribution can be approximately 50% from the electrical input and 50% from the heat and at around 2000° C., the energy contribution can be approximately 25% from the electrical input and 75% from the heat. At even higher temperatures, thermal decomposition occurs. It will be understood by persons of ordinary skill in the art that the ratio of electricity to thermal energy used as input energy for the HTE process can be varied according to the conditions under which the HTE operates. In general, if more heat energy is used, less electricity is required and vice versa.

If seawater is to be converted to fresh-water, the seawater is preferably pretreated to remove organics, algae, and fine particles if brackish water is used. Conventional processes can be used for the pretreatment.

If waste water or polluted water is to be converted to fresh water, pretreatment to remove waste material is preferred and conventional processes can be used for such pretreatment. The treated non-fresh water is then subjected to high temperature electrolysis.

An HTE system according to aspect of the present invention can operate at temperatures ranging from about 100° C. to about 850° C., a typical known range for HTE. At higher temperatures, more of the energy is derived from the heat thus requiring less electricity for the electrolysis. An HTE system according to another aspect of the present invention can operate at temperatures ranging from 850° C. to just below the thermolysis temperature (thermolysis temperature is about 3200° C. at 1 atm). An HTE system according to another aspect of the present invention can operate at temperature ranging from 1000° C. to just below the thermolysis temperature. An HTE system according to a still further aspect of the present invention can operate at temperature ranging from 100° C. to just below the thermolysis temperature.

Operating the HTE system at just below the thermolysis temperature, the energy required for hydrogen and oxygen production comes mainly (can be almost 100%) from heat generated by the combustion of hydrogen and oxygen (in a later stage of the process) and the remaining negligible amount from electricity. In this way, the hydrogen and oxygen production is mostly through heat, and electricity is used primarily to separate produced hydrogen and oxygen and avoid their recombination.

In one aspect, the present invention relates to converting almost all of the input seawater to fresh water where the Rosenbaum-Weisz Process has the potential of converting 97% seawater and 3% salts/mineral into 97% fresh water and 3% salts/minerals thereby providing fresh water for humans, industries, livestock and agriculture.

In another aspect, the present invention relates to a desalination system where the high temperature electrolysis units are operated at pressures greater than 1 atms. Such higher or elevated pressure reduces the volume required for the HTE and thus the volume of the electrolysis units and in turn the number of high temperature electrolysis units needed.

In a further aspect, the present invention provides to a system and method where the energy required for the HTE process is provided by harnessing the heat that is generated by the combustion of the hydrogen and oxygen (a green and renewable energy process) rather than burning fossil fuels, which are known to cause global warming.

In a still further aspect, the present invention relates to a system and method where fresh drinking water is provided from polluted waters by increasing water temperature thereby rejuvenating polluted rivers and stream, eliminating drugs and other deadly bacteria in waste treatment plants. The standard requirement for eliminating hazardous material in typical incineration process is by keeping the material at 2000° C. for 2 seconds. The present system in one embodiment provides such conditions for polluted and waste water.

In other embodiments of the present invention, a system using the Rosenbaum-Weisz Process can be installed in existing MSF desalination plants as well as SWRO desalination plants. Thus, the extensive non-renewable energy that contributes significantly to global warming, that is currently being consumed can be replaced by the implementation of the Rosenbaum-Weisz Process. In the case of the MSF desalination process, the waste heat from the adjacent cogeneration plants can be used to produce electricity or be used in an industrial/chemical process, since they will not be closed down.

In another embodiment of the present invention, a new plant using the Rosenbaum-Weisz Process does not require massive investments in the construction of an adjacent cogeneration power plant. Consequently, plants employing the Rosenbaum-Weisz Process can be located anywhere in the world since they are dependant on having a cogeneration power plant beside them to supply the required energy. Plants employing the Rosenbaum-Weisz Process can be located in a small village in Africa that has a small plant to convert seawater, brackish or polluted water to fresh water or in a large metropolitan city that has large plant converting, seawater, brackish or polluted water to fresh water since they are not depended on being located near a cogeneration power plant.

In a further embodiment of the present invention, plants employing the Rosenbaum-Weisz Process can be set up to provide vast amounts of fresh water that are required for industrial use and for power plants.

In a further embodiment of the present invention, plants employing the Rosenbaum-Weisz Process can be set up at or near the oil and/or gas field to process the produced water and flowback water produced in the oil and gas field thus providing the vast amounts of fresh water that are required for oil and gas production, oil and gas fracking and in bituminous sands (tar sands) operations thereby significantly reducing the water supply costs and water disposal costs.

In a further embodiment of the present invention the Rosenbaum-Weisz Process can be set up at or near industrial/chemical/processing plants, mines, foundries etc. to process the polluted water there from thereby significantly reducing the water supply costs and water disposal costs.

In a further embodiment of the present invention, portable units employing the Rosenbaum-Weisz Process can be set up near the oil spill to process the polluted water thereby reducing the oil spillage cost.

In still further embodiment of the present invention, the Rosenbaum-Weisz Process can provide fresh water from many non-fresh water sources and does not require the consumption of large amounts of non-renewable fossil fuels. Consequently, the Rosenbaum-Weisz Process can be a major contributor to the slowing down of the consumption of non-renewable fossil fuel and thus significantly contributing to the slowing down of global warming and thereby extending the life of non-renewable fossil fuel reserves.

The Rosenbaum-Weisz Process can be utilized by both rich and poor nations across the world since it requires very little purchase of external energy to operate.

### BRIEF DESCRIPTION OF THE DRAWINGS

FIG. 1 illustrates processes in high temperature electrolysis of non-fresh water producing fresh water according to certain embodiments of the invention.

FIG. 2 illustrates a high temperature electrolysis unit according to one embodiment of the present invention.

FIG. 3 illustrates a hydrogen and oxygen combustor according to one embodiment of the present invention.

FIG. 4 illustrates one embodiment of a heat exchanger used for extracting heat from a combustion of hydrogen and oxygen to produce superheated steam according to one embodiment of the present invention.

FIG. 5 illustrates one embodiment of the present process that is utilizing part of hydrogen and oxygen produced for external use and sale according to one embodiment of the present invention.

FIG. 6 illustrates one embodiment of the present process that is utilizing part of the heat extracted from superheated steam to generate electricity according to one embodiment of the present invention.

FIG. 7 illustrates one embodiment of the present process that is utilizing part of hydrogen and oxygen produced for external use and sale and utilizing part of heat extracted from superheated steam to generate electricity according to one embodiment of the present invention.

FIG. 8 illustrates one embodiment of the present process where hydrogen and oxygen are provided from other source(s) and/or process(es), in addition to hydrogen and oxygen generated by the high temperature electrolysis. The combined generated and provided hydrogen and oxygen are combusted to produce superheated steam and heat. The heat extracted from the superheated steam can be used to compensate for the heat losses in the system, to generate electricity and/or be used in an industrial/chemical process according to one embodiment of the present invention.

FIG. 9 illustrates the impact of temperature on the contribution of heat and electricity according to one embodiment of the present invention.

FIG. 10 illustrates a system according to one embodiment of the present invention where an evaporator and an electrolysis unit are separate.

FIG. 11 illustrates a system according to one embodiment of the present invention which includes a mixing station to reduce scaling.

FIG. 12 illustrates a system according to one embodiment of the present invention which includes utilizing heat from cooling and compression of hydrogen and oxygen gases.

FIG. 13 illustrates a system according to one embodiment of the present invention where a high temperature electrolysis unit also includes a combustor and a water pipe. This embodiment does not require the use of a high temperature heat exchanger system.

FIG. 14 illustrates a system according to one embodiment of the present invention that details a high temperature electrolysis unit that includes a combustor and a water pipe.

### DESCRIPTION OF THE PREFERRED EMBODIMENT

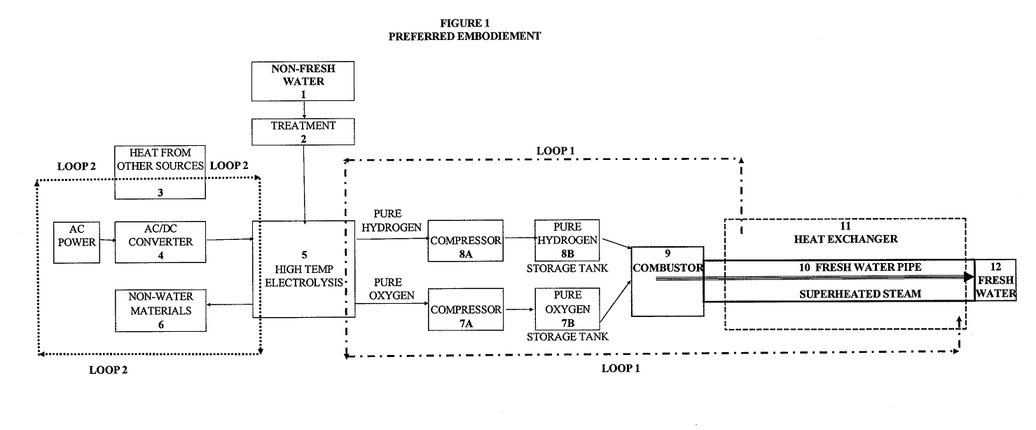

Referring initially to FIG. 1, in one embodiment, of the present invention all of the hydrogen and oxygen that is generated by the high temperature electrolysis process is combusted at elevated pressure to produce high pressure high temperature superheated steam. The heat generated through the combustion of hydrogen and oxygen is then extracted by the heat exchanger system and is recycled to be used in the high temperature electrolysis process. The extraction of the heat by the heat exchanger system condenses the superheated steam to produce fresh water.

The process can be summarized as follows:

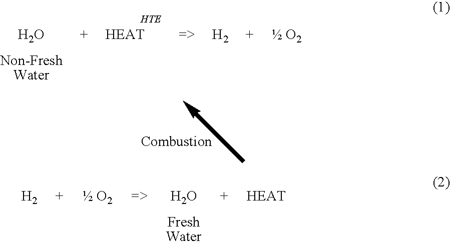

As shown in equation (1), non-fresh water is heated to create supersaturated steam and using the high temperature electrolysis process the supersaturated steam is separated into hydrogen and oxygen. The generated hydrogen and oxygen is then combusted to create supersaturated steam and heat as shown in equation (2). The heat generated by the process of combustion of hydrogen and oxygen is then recovered to be used for the required heat in the high temperature electrolysis process.

Non-fresh water 1 is first taken to a treatment station 2. Non-fresh water is treated to remove organics, algae and particulate such as sand. Fine particles are removed if brackish water is used as the input water. Waste material is removed if waste water is used as input water. Polluted water from any source (including but not limited to: water from oil and gas production, flowback water from fracking, water production from tar sands, water from chemical/industrial/processing plants, water from mining/foundries operations and oil spillage etc.) can be used as the input water. Conventional processes can be used for such removal of non-water materials (such as gas, oil residues, minerals, metals, etc.) from the non-fresh water will be understood by those of ordinary skill in the art.

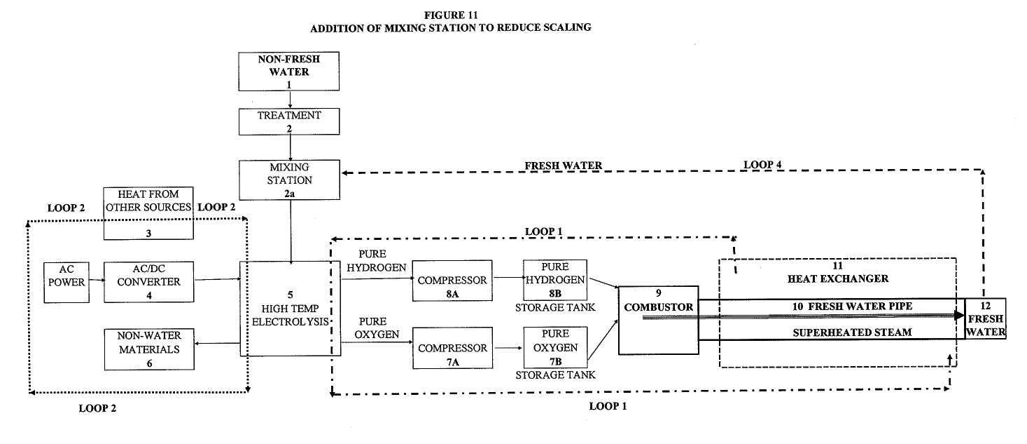

Scaling can be an issue, as in the case of seawater where salts and minerals can cause scaling issues, in the conversion of non-fresh water to fresh water. Using seawater as an example, the scaling issue becomes more acute as the treated seawater is evaporated thereby increasing the relative concentration of salts and minerals in the remaining seawater. In another embodiment of the present invention as shown in FIG. 11 in order to minimize the scaling caused by the evaporation of the treated seawater, the relative concentration of the salts and minerals in the treated seawater is diluted by mixing the treated seawater with fresh water, as provided by loop 4, in the mixing station 2A prior to the high temperature electrolysis (“HTE”) unit 5. The amount of fresh water that is used to dilution can be substantially greater than the amount of original treated seawater. The resulting increased combined treated seawater is then directed to the HTE unit. The resulting increased quantity of hydrogen and oxygen that is produced by the HTE process will generate increased quantities of heat and fresh water by the combustion of hydrogen and oxygen in the combustion chamber. A portion of the fresh water that is produced at the end of the water pipe is diverted back to mixing station 2A by loop 4 while the remaining part will be the net output of fresh water produced by the Rosenbaum-Weisz Process. It should be noted that the mixing station 2A and this looping back process is not necessary where scaling is not an issue. It will be understood by those skilled in the art that any number of suitable types of collection vessels (referred to generally as a “collector”) can be used in place of a water pipe for condensing steam and the present invention is not limited to the use of a water pipe.

The next step in the process is the high temperature electrolysis process 5. In this stage, the treated non-fresh water is electrolyzed into hydrogen and oxygen. The electrolysis process is through high temperature electrolysis, in which the treated non-fresh water is heated to extreme temperature operation just below the thermolysis temperature. Electrolysis at a temperature of 3150° C. can be used for example. Consequently, only a relatively small amount of electricity is required to cause the hydrogen and oxygen to separate and flow in different channels after decomposition. The required heat for the high temperature electrolysis is provided from the combustion of hydrogen and oxygen at elevated pressure in a later stage of the process. The required electricity for the electrolysis process, whose only purpose is to separate hydrogen and oxygen, can be purchased from an outside source or may even be produced by utilizing the excess heat produced at various stages of the present method. Alternatively, the excess heat can be used as an energy input for an electricity generator such as a steam turbine and the energy produced can be sold. High temperature electrolysis process is an established process and consequently, the selection of electrodes and the construction of HTE unit are within the knowledge of a person of ordinary skill in the art. There are several methods of constructing high temperature electrolysis systems. One method is described by Jensen, Larsen and Mogensen, the details of which are incorporated herein by reference (International Journal of Hydrogen Energy, 32 (2007) 3253-3257.

FIG. 1 illustrates, heat from combustion, the addition of heat 3 (if required), and electricity 4 are provided to the high temperature electrolysis unit 5. The high temperature electrolysis unit contains two sections, the evaporation chamber and the high temperature electrolysis section. Additional heat from outside sources may be required so as to compensate for any heat losses in the system such as heat exchanger inefficiencies. Electricity, whose sole purpose will be to separate the hydrogen and oxygen, will be negligible and may be purchased from outside sources or generated by capturing the lost heat at various stages in the plant. External sources, such as energy from wind, solar, fossil fuel, nuclear and geothermal sources can be used to compensate for the heat losses and/or supply the minimal electrical need to separate the hydrogen and oxygen.

The treated non-fresh water is taken into the evaporation chamber section where the treated non-fresh water is turned into steam by the addition of some of the recycled heat (carried by suitable piping) from the combustion of hydrogen and oxygen at elevated pressure in a later stage of the process. The purpose of the separate evaporation chamber section is to pre-heat the treated non-fresh water thereby separating the water portion of the non-fresh water from the non-water materials (such as gas, oil residues, minerals, metals, etc.) by evaporating the water component of the treated non-fresh water into steam and then subjecting the steam to extreme temperatures, just below the thermolysis temperature in the high temperature electrolysis section.

Consequently, the steam in the evaporation chamber section will be substantially pure and will not contain non-water materials. As a result of thermal expansion the steam then flows into the high temperature electrolysis section where additional heat, the balance of the recycled heat from the combustion of hydrogen and oxygen at elevated pressure, is added. Non-water materials at the bottom 6 of the HTE unit are removed, preferably continuously Conventional processes can be used for such removal of non-water materials and will be understood by those of ordinary skill in the art.

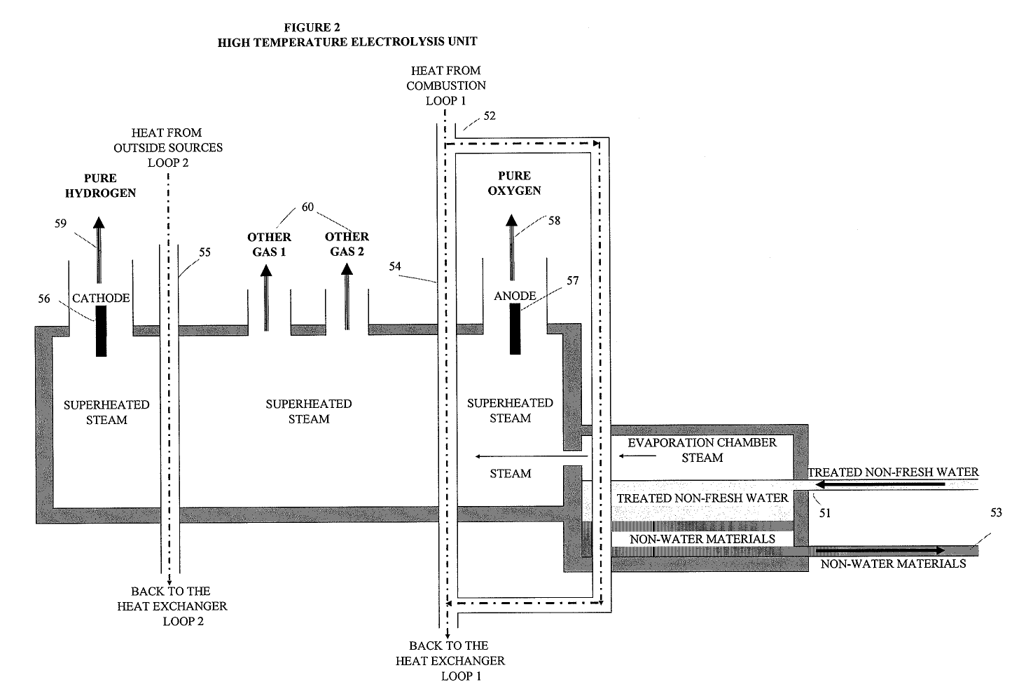

As shown in FIG. 2, treated non-fresh water enters the evaporation chamber section of the HTE unit at 51. Some heat is diverted from the recycled combustion heat at 52 and it heats up the treated non-fresh water to create steam. The remaining non-water materials are removed, preferably continuously from the evaporation chamber at 53. The recovered non-water materials (in the case of seawater recovered salts and minerals) can be sold thereby providing an additional source of revenue. As a result of thermal expansion, the steam in the evaporator chamber section will then flow into the high temperature electrolysis section of the HTE unit 5 where additional heat from the recycled combustion heat is added to the steam through a heat exchanging system 55 and 54. Most of the heat needed for this process is generated internally 54 through loop 1 that recycles the heat that is provided by the combustion of the hydrogen and oxygen at elevated pressure in a later stage of the process. Any additional heat, if needed, comes from external sources 55 through loop 2. Two electrodes, cathode 56 and anode 57 located inside the HTE unit 5 act to separate the oxygen 58 and hydrogen 59. The minimal amount of electricity that is required for the high temperature electrolysis process is supplied to the electrodes by the AC/DC converter unit 4. In cases where the non-fresh water contain gas, oil residues or other gases, the heat generated by the electrolysis process may release addition gases other than hydrogen or oxygen at some stage of the process. These other gases 60 will be recovered and can be sold thereby providing an additional source of revenue.

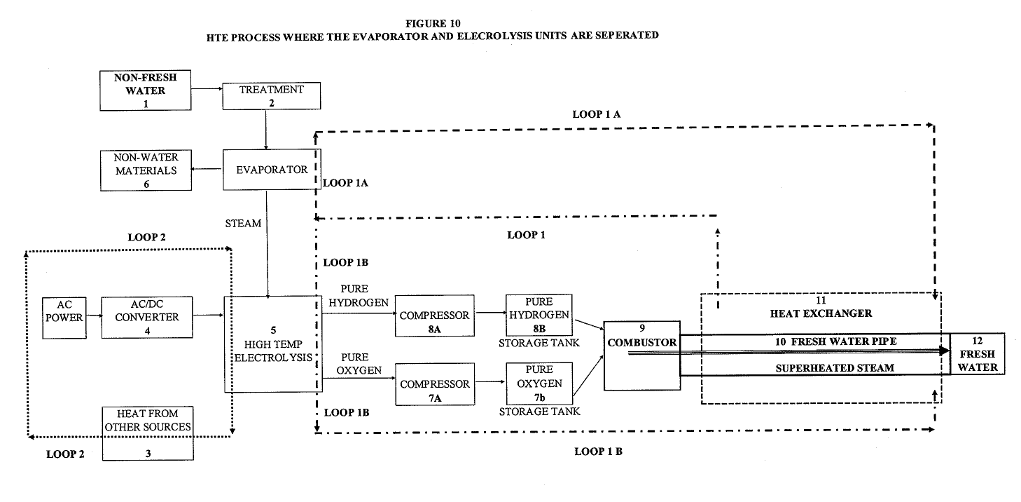

In an alternate embodiment of the present invention as shown in FIG. 10, the evaporation chamber section and the high temperature electrolysis section can be two separate equipment units rather than two sections within the same unit.

In an alternate embodiment of the present invention, the evaporation chamber section in the HTE unit may not be employed. In this situation all of the heating and the removal of the salts and minerals occur in the high temperature electrolysis section.

Preferably, the evaporator section (whether part of the HTE unit or separated) and the high temperature electrolysis section of the HTE unit 5, the combustor 9 and the high temperature heat exchanger 11 are insulated so as to minimize heat loss and maximize their efficiencies. The selection of insulating materials is within the knowledge of a person of ordinary skill in the art.

Preferably, the evaporator section (whether part of the HTE unit or separated) and the high temperature electrolysis section of the HTE unit 5 and the mixing station 2A are made of material suitable to withstand the presence of the salts and minerals so that to minimize corrosion. The selection of the appropriate material is within the knowledge of a person of ordinary skill in the art.

Once hydrogen and oxygen are generated and separated by the HTE unit 5, they are compressed and stored in different storage tanks under pressure. Elevated pressure is used so as to minimize the amount of the required storage. A compressor 7A is used to compress and move the oxygen into a storage tank 7B, and a compressor 8A is used to compress and move hydrogen into a storage tank 8B. The hydrogen and oxygen gases leaving the HTE unit will be at elevated temperature. The hydrogen and oxygen gases will be compressed by their respective compressor operating at elevated pressure (i.e. greater than 1 atmosphere). A compression pressure of 2 atmospheres can be used for example. Once compressed, heat may be extracted from the hydrogen and oxygen gases so as to reduce their volatility and/or to reduce the required storage space.

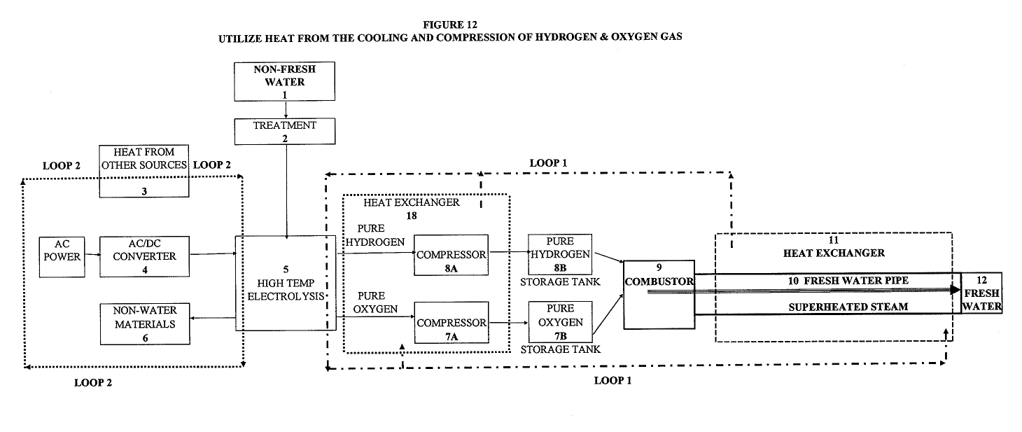

Another embodiment of the present invention as shown in FIG. 12, the heat from the heated hydrogen and oxygen is extracted by way of one or more heat exchangers 18 and by the compression of the gases. The extracted heat can be used in the evaporation chamber and/or the evaporator unit, generate electricity, or in other parts of the process for example, the drying of the salts/minerals/metals which are extracted. If the extracted heat is used to generate electricity then the generated electricity can be used for internal use (thereby reducing the plant's external electrical purchase) or be sold to an external source resulting in a revenue stream.

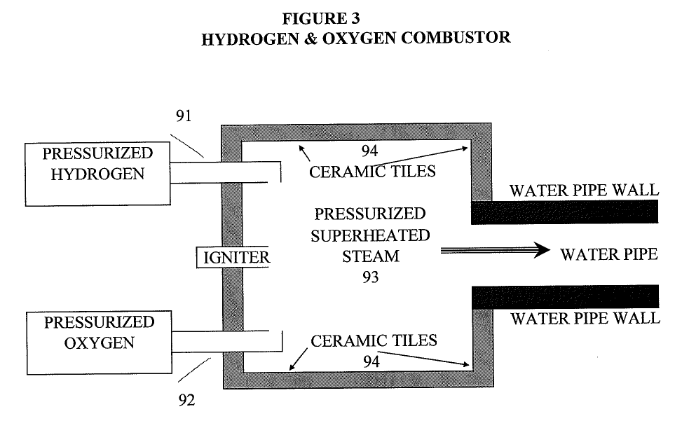

As shown in FIG. 3, hydrogen at elevated pressure 91 and oxygen at elevated pressure 92 are then injected into a combustor 9 to generate superheated steam 93. The pressurized hydrogen and oxygen ensures that the combustion will occur under high pressure thus preventing air from entering the combustor thereby preventing the creation of nitrous oxide (“NOX”). The combustion pressure will exceed 1 atmosphere so as to exclude the air from entering the combustor. A combustion pressure of 2 atmospheres can be used for example. The combustion chamber is designed to withstand high combustion temperatures without significant heat loss. The combustion chamber is preferably constructed of refractory materials or has high temperature ceramic surface coatings 94. Another means for carrying out high temperature combustion is described in U.S. Pat. No. 7,128,005, details of which are incorporated herein by reference. The combustion process produces superheated steam at high pressure and high temperature. The heat from the superheated steam is extracted through a high temperature heat exchanger system 11. The material in the system is chosen from material that is suitable for high temperature operation. Current technology has the capacity to deal with heat in excess of 3200° C. For example, there are ceramics that can withstand the heat and thus could line the surface of the combustor, the appropriate selection of which is within the knowledge of a person of ordinary skill in the art.

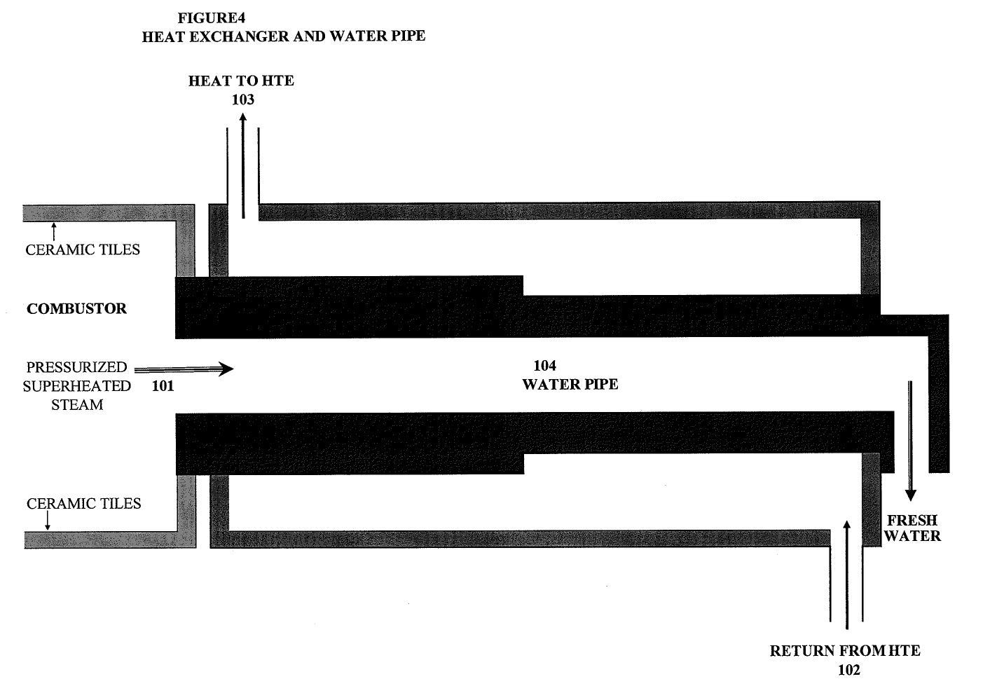

As shown in FIG. 4, the superheated steam 101 so produced is at a combustion temperature of about 3200° C. at 1 atm. The actual combustion temperature will be higher since the combustion will occur at elevated pressure. The higher the pressure the higher the combustion temperature (for example, the combustion temperature is about 3353° C. at the pressure of 2 atm). This high temperature superheated steam then flows through a water pipe 10, transferring heat to a high temperature heat exchanger system 11. The returned heat exchanger fluid enters the heat exchanger system at 102. The heat energy extracted by the heat exchanger system from the high pressure high temperature superheated steam is then returned to the high temperature electrolysis unit 103 to heat the treated non-fresh water through loop 1. The superheated steam produced by the high pressure combustion process is cooled by the extraction of the heat by the high temperature heat exchanger system to produce fresh water stored in a fresh water tank 12. The water pipe 104 serves the purpose of containing the superheated steam isolated so that no impurities are introduced into the process of fresh water creation. The water pipe and the combustor are hermetically sealed thereby ensuring that no air or contaminants will enter the process. The superheated steam exiting from the combustor to the water pipe is also under high pressure thus ensuring that no air will enter the water pipe.

The wall thickness of the water pipe can be tapered as the temperature gradient reduces along the water pipe due to heat extraction. The tapered wall reduces the cost of the water pipe. Heat is extracted from the water pipe by way of suitable high temperature heat exchanger system. The combustor and the water pipe containing high pressure high temperature superheated steam and are made of material that can stand high pressure and high temperatures. The heat exchanger fluid is not in direct contact with the super saturated steam which is contained in the water pipe. Many known industries such as nuclear plants, foundries, rockets etc. operate at very high temperatures and consequently, the selection of appropriate heat exchanger and heat exchanger fluids suitable for the Rosenbaum-Weisz Process is within the knowledge of a person of ordinary skill in the art.

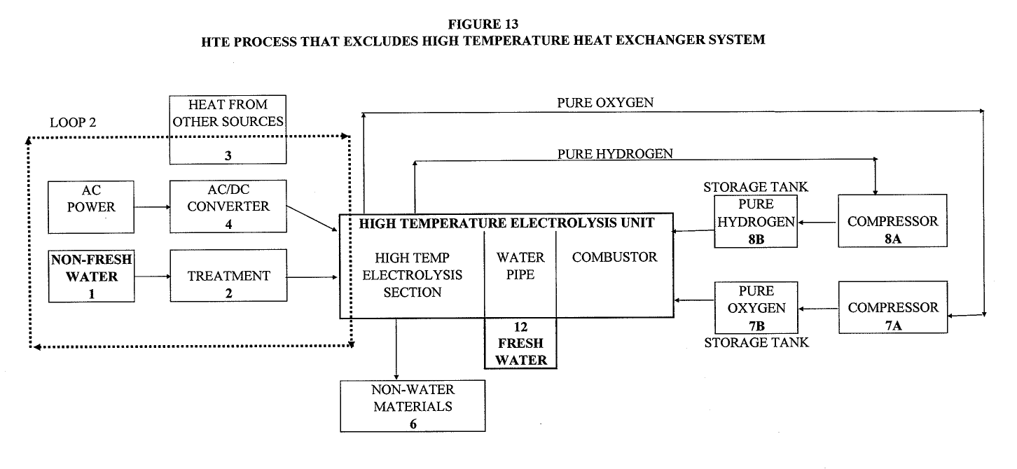

In another embodiment of the present invention as illustrated in FIG. 13, where the HTE unit also contains, the combustor and the water pipe. This configuration does not require the high temperature heat exchanger system thereby reducing the capital cost and significantly reducing the system heat loss. Unlike previous embodiments, in this embodiment the water pipe is in direct contact with the HTE unit.

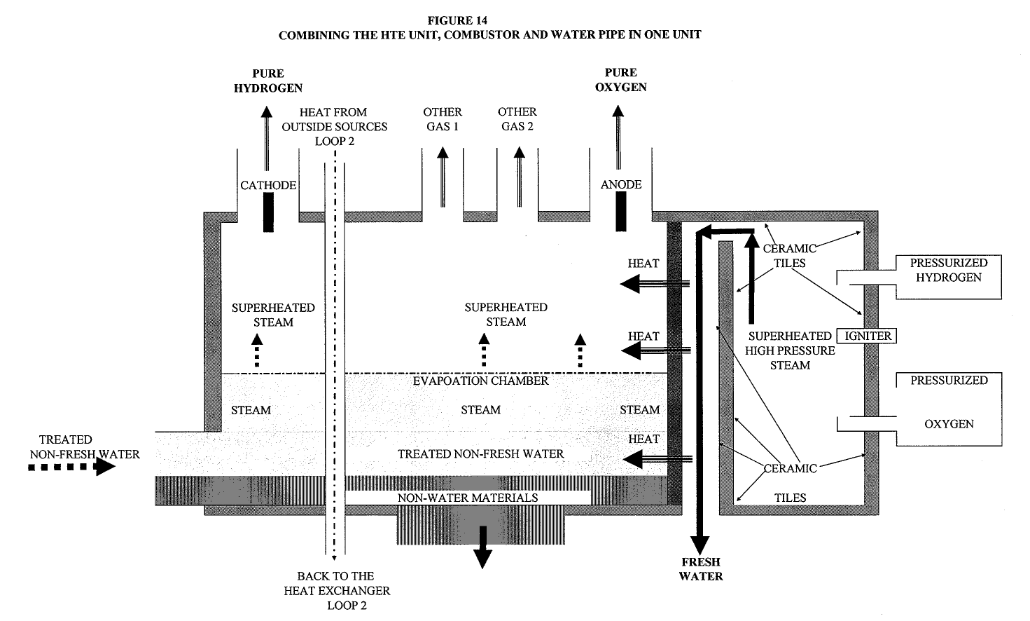

In another embodiment of the present invention as illustrated in FIG. 14 illustrates the details of the HTE unit that also has the combustor and the water pipe. The wall that the water pipe and combustor share in common is covered by ceramic tiles so as to prevent heat transfer between them so as to eliminate heat losses. Conversely, the wall that the water pipe and the HTE unit share in common is not covered by ceramic tile so that there is maximum heat transfer from the water pipe to the high temperature electrolysis section. The higher the amount of heat transfer to the high temperature electrolysis section the lower the amount of electricity that is required for electrolysis. This embodiment may be furthered refined by excluding the evaporation section from the HTE unit. The selection of the ceramics that can withstand the heat and thus could line the surface of the combustor and the water pipe is within the knowledge of a person of ordinary skill in the art. The selection of appropriate materials suitable for the water pipe is within the knowledge of a person of ordinary skill in the art. This is the only situation in which part of the surface of the water pipe is covered by ceramic tiles so as to prevent heat transfer. In all other embodiments the contain heat exchanger system none of the water pipe surface is covered by ceramic so as to maximize the heat transfer from the water pipe to the heat exchanger system.

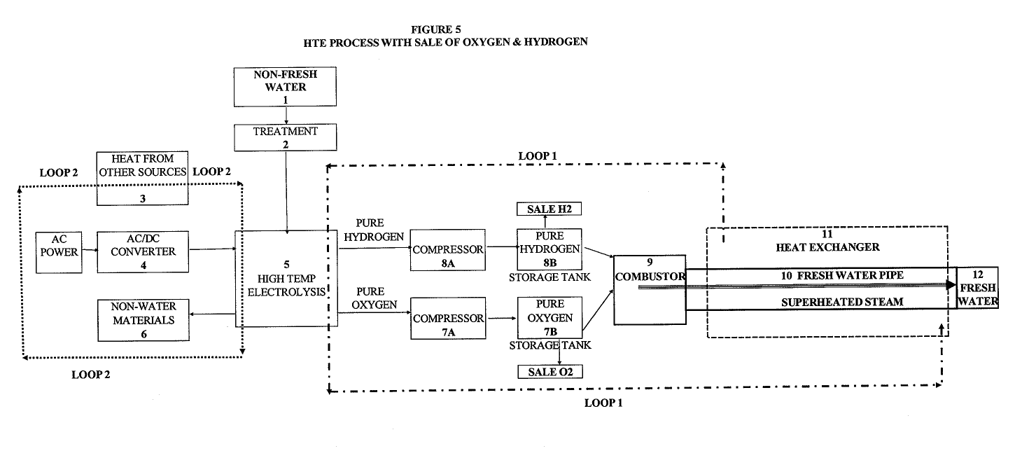

In another embodiment of the present invention as illustrated in FIG. 5, some of the hydrogen and oxygen is sold rather than be used to generate heat. Some of the oxygen and hydrogen are extracted from the storage tanks 7B and 8B for external use. Thus, this process can be used to generate hydrogen for the hydrogen economy. The selling of some of the hydrogen and oxygen implies that less hydrogen and oxygen is combusted in the combustor. The extraction of hydrogen and oxygen results in reducing the amount of heat available to the HTE process from the combustion of hydrogen and oxygen. Thus, the reduction of the heat from the combustion can be made up by increasing the amount of heat and or electricity that would be required to be purchased from outside sources. This is an arbitrage situation. The amount of hydrogen that can be sold is a function of the difference in the sum of the cost of purchasing heat and/or electricity and the reduction of fresh water revenue versus the revenue that could be generated by the sale of hydrogen and oxygen.

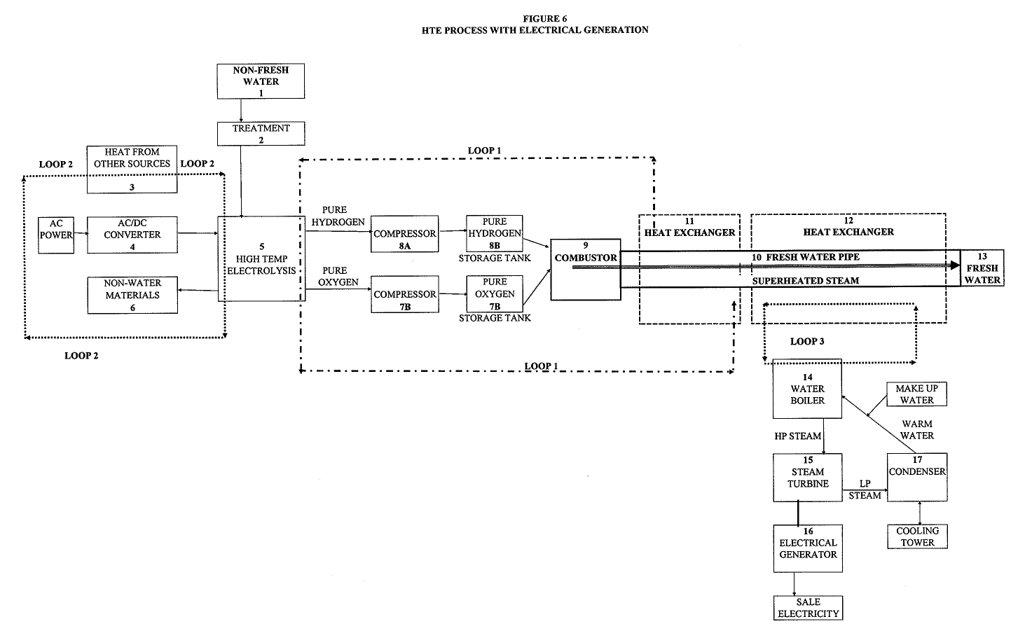

Another embodiment of the present invention is illustrated in FIG. 6, where some of the heat that is generated by the combustion of hydrogen and oxygen can be diverted to a steam generator to be converted by a steam turbine into electricity. All of the hydrogen and oxygen are used for combustion. There is no sale of hydrogen or oxygen. Part of the combustion heat is captured through another heat exchanger 12 and carried through loop 3 to a steam generator 14. The generated steam is then taken to a steam turbine 15 to generate electricity 16. The extraction of the heat to generate electricity will result in reducing the amount of heat available to the HTE process from the combustion of hydrogen and oxygen. Thus, the reduction of the heat from the combustion can be made up by increasing the amount of heat and/or electricity that would be required to be purchased from outside sources. One reason that one would do this is because some of the generated electricity may be classified as “green electricity” thereby enabling the plant to get a high premium price for the generated electricity. This is an arbitrage situation. Typically, however, the capital cost required for the generation of electricity would make it uneconomical to generate and sell electricity unless there was a premium paid for the generated electricity.

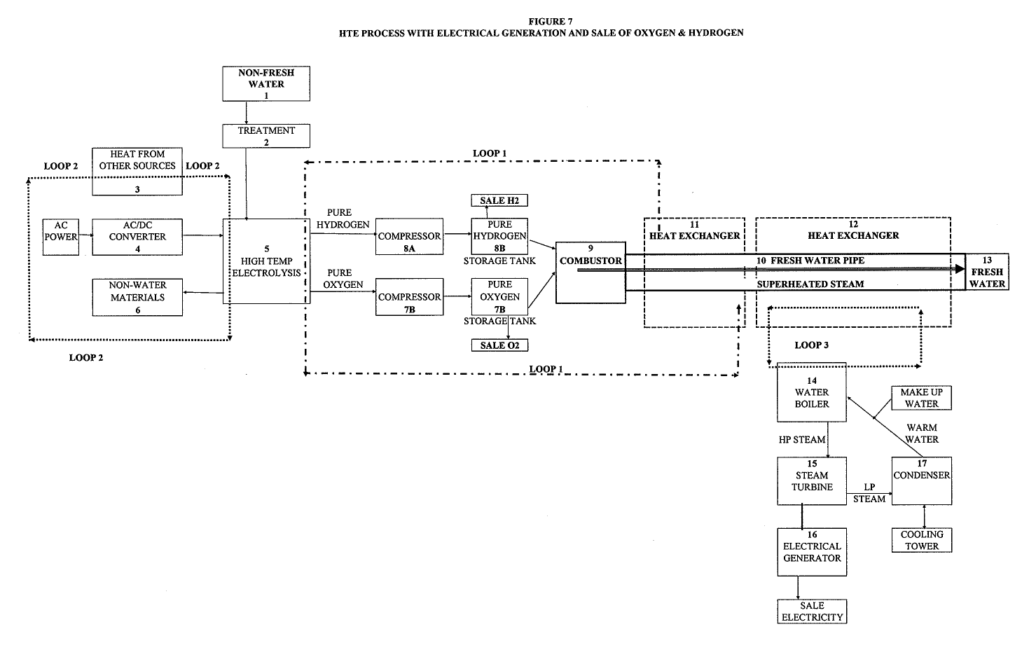

Another embodiment of the present invention as shown in FIG. 7 is a combination of extraction of hydrogen and oxygen as well as producing electricity.

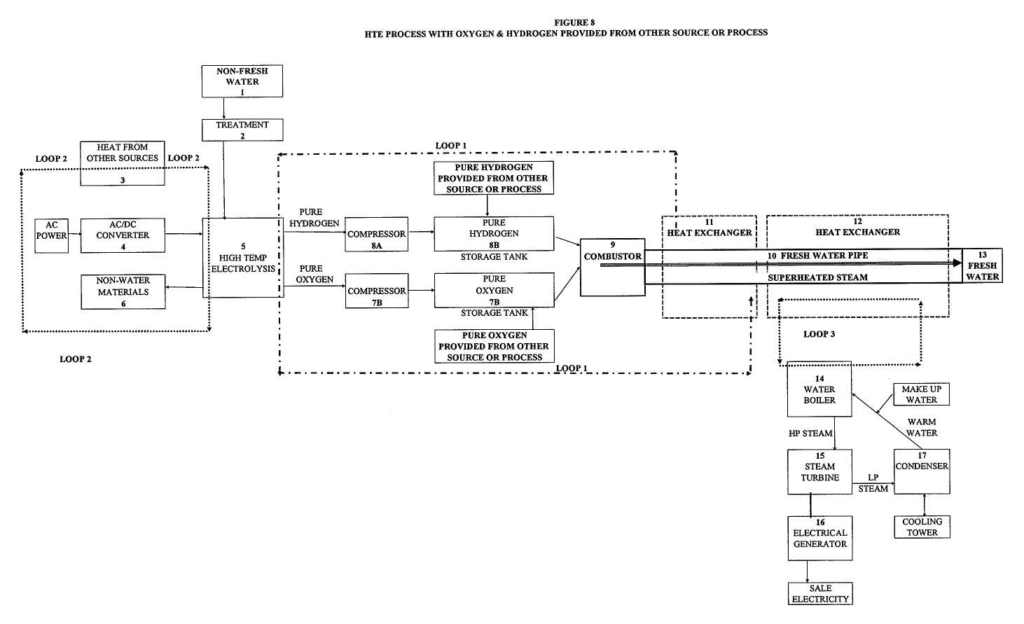

Another embodiment of the present invention as shown in FIG. 8 illustrates a process where hydrogen and oxygen are provided from other source(s) and/or process(es) and the hydrogen and oxygen that is produced by the high temperature electrolysis are combined to be combusted at elevated pressure to produce superheated steam at high pressure and high temperature. The heat extracted from the superheated steam can be used to compensate for the heat losses in the system, generate electricity and/or be used in an industrial/chemical process. This may be done where the cost of the additional hydrogen and oxygen is less than the purchase of heat from other sources to compensate for the heat losses in the system. Another reason for doing this is if the revenue from electricity produced exceeds the cost of the additional hydrogen and oxygen.

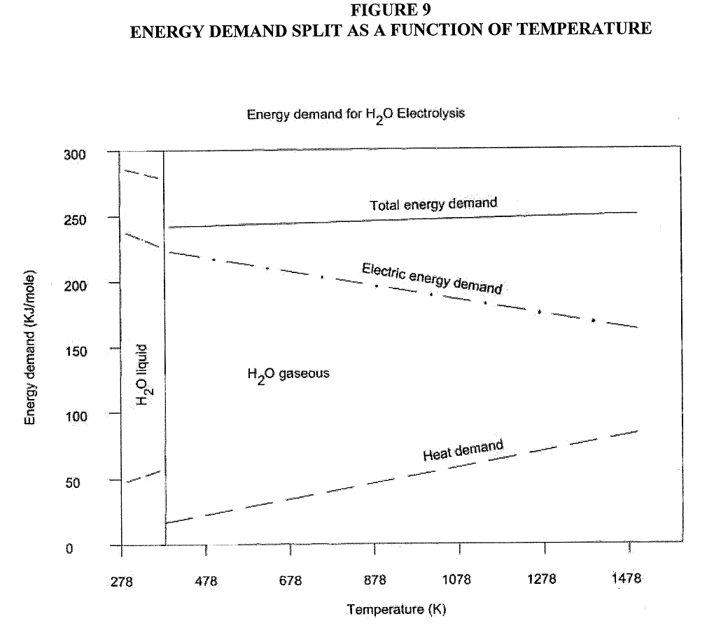

To demonstrate the ability of this method to minimize the electricity usage for hydrogen and oxygen production two sample cases have been considered. FIG. 9 (taken from an article published in the International Journal of Hydrogen Energy 32 (2007) 3253-3257 by Soren H. Jensen, Peter H. Larsen, Mogens Mogensen of the Riso National Laboratory) illustrates the relationship between the contribution of heat and electricity as a function of temperature. The temperature range is consistent with the typical temperature of the waste heat from a cogeneration plant. Extrapolating the relationship, for electrolysis occurring at 1500° C., it is estimated that 50% of the required energy will come from heat and 50% from electricity (Case A). If the electrolysis occurs at 2000° C. then it is estimated that 75% of the required energy comes from heat and 25% from electricity (Case B). It should be noted that energy provided by the heat is almost 100% if the electrolysis is at around thermolysis.

The above cases clearly demonstrate that electricity purchases are significantly reduced even in the cases where only 75% of the energy requirement comes from heat. For the proposed invention almost 100% of the energy will be provided from the heat generated by the combustion of hydrogen and oxygen. It can be easily predicted that electricity purchase, whose sole purpose will be to separate the hydrogen and oxygen, will be negligible.

In an alternate embodiment, the system and process of the present invention with appropriate modification can be used with a sewage treatment plant to eliminate impurities and hazardous materials in the non-fresh water being processed. Current process to elimination hazardous material requires the incineration of such materials at 2000° C. for 2 seconds which is very expensive. Using the Rosenbaum-Weisz Process results in an electrolysis temperature in excess of 3000° C. thereby eliminating all of the hazardous material as part of the process.

It will be understood by those skilled in the art that the process of the present invention can be used on a variety of scales such as from a small plant that purifies water in a small village to large desalination plant providing fresh water to a major metropolitan city.

It will be further understood by those skilled in the art that the system of the present invention can be configured in a number of ways. For example, in certain embodiments, multiple units can be used such as, but not limited to, two HTE units, three combustors, and four heat exchangers. The mixing station 2A, loop 4 and heat exchanger 18 can likewise be optionally included in systems according to the invention as needed.

While preferred processes are described, various modifications, alterations, and changes may be made without departing from the spirit and scope of the process according to the present invention as defined in the appended claims. Many other configurations of the described processes may be useable by one skilled in the art.

What is claimed is:

1- A method of converting non-fresh water to fresh water, comprising the steps of:
(a) subjecting the non-fresh water to high temperature electrolysis whereby hydrogen gas and oxygen gas are produced and separated;
(b) compressing, cooling and storing the separated hydrogen gas and oxygen gas at elevated pressure;
(c) combusting the hydrogen gas and the oxygen gas at elevated pressure to produce superheated steam at high temperature;
(d) collecting superheated steam produced by the combustion in step (c);
(e) recovering heat from the superheated steam whereby at least some of the superheated steam condenses to produce fresh water; and;
(f) using at least some of the recovered heat as an energy input in step (a).

2- The method of claim 1, wherein the non-fresh water is selected from the group consisting of seawater, brackish water, waste water, polluted water, and water from a source selected from the group consisting of water from oil and gas production, flowback water from fracking, water production from tar sands, water from chemical/industrial/processing plants, water from mining/foundries operations and oil spillage.

3- The method of claim 2, further including the step of pre-treating the non-fresh water.

4- The method of claim 3, wherein the pre-treatment step comprises removing from the non-fresh water the non-water materials component selected from the group consisting of organics, algae and particulate such as sand, waste material, oil residues, metals and other impurities.

5- The method of claim 4, further including the step of
(g) pre-heating the treated non-fresh water prior to step (a); and
(h) removing the non-water materials such as salts and minerals, metals etc. prior to step (a).

6- The method of claim 5, further including selling the non-water materials recovered in step (h).

7- The method of claim 1, wherein the recovery of heat in step (e) uses a high temperature heat exchanger process.

8- The method of claim 7, further including in step (g), elevating the treated non-fresh water to a temperature sufficient to create steam and supplying the steam for step (a).

9- The method of claim 8, further including the step of using at least some of the recovered heat of step (e) for step (g).

10- The method of claim 9, further including the step of using at least some of the recovered heat of step (e).

11- The method of claim 1, further including the step of supplying energy for step (a) at least partially from an external source.

12- The method of claim 11, wherein the external source of energy is selected from group consisting of solar energy, wind energy, nuclear energy, fossil fuel energy, and geothermal energy.

13- A system for producing fresh water comprising:
a pretreatment unit for pre-treating non-fresh water;
a high temperature electrolysis unit for receiving treated non-fresh water and for producing and separating hydrogen and oxygen gas from the treated non-fresh water;
a first compressor unit for compressing hydrogen gas produced and separated by the electrolysis unit;
a second compressor unit for compressing oxygen gas produced and separated by the electrolysis unit;
a hydrogen and oxygen combustor operable at elevated temperature and elevated pressure for producing superheated steam under high pressure temperature and pressure;
a collector connected to the combustor for collecting superheated steam produced by the combustor and wherein the collector is hermetically sealed to the combustor;
a storage unit for fresh water produced in the collector.

14- The system of claim 13, further including a high temperature heat exchanging unit for recovering heat from the superheated steam in the collector.

15- The system of claim 14, wherein the high temperature electrolysis unit is comprised of an evaporation chamber section and a high temperature electrolysis section.

16- The system of claim 15, further including means for transferring the recovered heat from the collector to the high temperature electrolysis unit.

17- The system of claim 16, further including means for diverting part of the heat to the evaporation chamber and the balance to the high temperature electrolysis section of the high temperature electrolysis unit.

18- The system of claim 17, further wherein includes a heat exchanging unit for transferring recovered heat to the treated water in the evaporation chamber to produce steam.

19- The system of claim 18, further including means for transferring the steam produced in the evaporation chamber to the high temperature electrolysis section of the high temperature electrolysis unit.

20- The system of claim 18, further including means for continuously removing the salts, minerals, metals and other contaminants from the evaporation chamber section.

21- The system of claim 19, further including a heat exchanging unit for transferring the balance of the recovered heat to the high temperature electrolysis section of the high temperature electrolysis unit.

22- The system of claim 15, further including means for supplying DC current is to the high temperature electrolysis section of the high temperature electrolysis unit from the AC/DC converter.

23- The system of claim 15, further including means for supplying heat from external sources to the high temperature electrolysis section of the high temperature electrolysis unit.

24- The system of claim 15, further including means for separating the hydrogen gas and oxygen gas from the steam by way of electrodes.

25- The system of claim 15, further including means for transmitting the separated hydrogen gas from high temperature electrolysis unit to the corresponding compressor unit and to be stored in a pressurized tank.

26- The system of claim 15, further including means for transmitting the separated oxygen gas from high temperature electrolysis unit to the corresponding compressor unit for storage in a pressurized tank.

27- The system of claim 25, wherein the hydrogen gas compressor is adapted to operate under elevated pressure and elevated temperature.

28- The system of claim 27, wherein the storage tank is adapted to store the hydrogen gas under elevated pressure.

29- The system of claim 26, wherein the second compressor is adapted to operate under elevated pressure and elevated temperature.

30- The system of claim 29, wherein the storage tank is adapted to store the oxygen gas under elevated pressure.

31- The system of claim 15, further includes means for insulating the evaporation section and the high temperature electrolysis section of the high temperature electrolysis unit so as to minimize heat loss.

32- The system of claim 14, further including means for transmitting the high pressure hydrogen gas from its high pressure storage tank to the hydrogen and oxygen combustor.

33- The system of claim 14, further including means for transmitting the high pressure oxygen gas from its high pressure storage tank to the hydrogen and oxygen combustor.

34- The system of claim 14, wherein the combustor comprises refractory material.

35- The system of claim 34, further including means for insulating the combustor so as to minimize heat loss.

36- The system of claim 14, further including means for insulating the high temperature heat exchanger system so as to minimize heat loss.

37- The system of claim 14, wherein the thickness of wall of the collector is tapered along its length.

38- The system of claim 37, wherein the collector is adapted to operate under elevated pressure and elevated temperature.

39- The method of claim 1, further including the step of removing part of the generated hydrogen gas and oxygen gas of step (a) whereby the removed hydrogen and oxygen are not used in step (c).

40- The method of claim 39, further including the step of selling at least some of the removed hydrogen gas and oxygen gas.

41- The system of claim 14, further comprising means for removing part of the generated hydrogen gas.

42- The system of claim 14, further comprising means for removing part of the generated oxygen gas

43- The method of claim 1, further including the steps of
(i) removing part of the heat recovered from the collector of step (e) whereby the removed heat is not used in step (a); and
(j) using some of the recovered heat as an energy input for another process.

44- The method of claim 43, wherein the process in step (j) is the production of electricity.

45- The method of claim 44, wherein the production of electricity includes using the heat of step (i) to heat water to create steam to run a steam turbine.

46- The system of claim 14, further comprising means for removing part of the heat recovered from the collector to another process.

47- The system according to claim 46, wherein the industrial process is an electricity generating unit.

48- The method of claim 1, further comprising supplying additional hydrogen gas and oxygen gas for step (b) from a source other than the high temperature electrolysis of step (a).

49- The system of claim 14, wherein means to facilitate the additional hydrogen gas and oxygen gas supplied for from a source other than the high temperature electrolysis process.

50- The system of claim 15, wherein the evaporation chamber section is a unit separate from the electrolysis unit.

51- The method of claim 1 further comprising the step of
(k) diluting the non-fresh water of step (a).

52- The method of claim 51, wherein step (k) comprises adding fresh water to the non-fresh water.

53- The method of claim 52, wherein the fresh water added in step (k) is obtained from the condensed water of step (e).

54- The system according to claim 14, further comprising a mixing station for diluting non-fresh water.

55- The system according to claim 54, further comprising a conduit connecting the fresh water storage unit to the mixing station for introducing fresh water into the mixing station.

56- The method of claim 1, further comprising the step of extracting heat from the cooling and compression of the hydrogen gas and oxygen gas.

57- The method of claim 56, further comprising the step of using the extracted heat as an energy input in another process.

58- The method of claim 57, where another process is selected from the group of industrial processes consisting of a process of adding additional heat to step (f) an electricity generation process, and a drying process.

59- The method of claim 58, further comprising a step selected from the group consisting of selling and using at least some of the electricity produced by the electricity generation process.

60- The system of claim 14, further comprising a heat exchanger for extracting the heat from the cooling of the hydrogen gas and oxygen gas and from the compression of such gases.

61- The system of claim 60, further comprising means for using the extracted heat in an industrial process selected from the group consisting of adding heat to the heat recovered from the collector, an electricity generation process, and a drying process.

62- The system of claim 14, further including means for minimizing the corrosion of any part that is in contact with salts and minerals.

63- The system of claim 14, wherein the high temperature electrolysis unit also includes a collector and a combustor.

64- The system of claim 14, wherein the wall that the collector and combustor share in common is covered by ceramic tiles.

65- The method of claim 1 wherein the high temperature electrolysis of step (a) is carried out at a temperature ranging from 100° C. to just below thermolysis.

66- The method of claim 1 wherein the high temperature electrolysis of step (a) is carried out at a temperature ranging from 1000° C. to just below thermolysis.

67- The method of claim 1 wherein the high temperature electrolysis of step (a) is carried out at a temperature ranging from 850° C. to just below thermolysis.

68- The method of claim 1 wherein the high temperature electrolysis of step (a) is carried out at a temperature ranging from 100° C. to just below 850° C.

69- The method of claim 1, further including the removing of gases other than hydrogen and oxygen generated by the high temperature electrolysis process.

70- The method of claim 69, further including the selling of the recovered gases other than hydrogen and oxygen generated by the high temperature electrolysis process.

71- The system of claim 15, further including means for removing gases other than hydrogen and oxygen generated by the high temperature electrolysis process.

72- A high temperature electrolysis unit comprising a combustor, a collector and a high temperature electrolysis section.

73- The system of claim 72, further wherein the high temperature electrolysis unit further comprising an evaporation chamber.

74- The system of claim 73, further including means for minimizing the corrosion of any part that is in contact with salts and minerals.

75- The system of claim 74, further including means for continuously removing the salts, minerals, metals and other contaminants from the high temperature electrolysis unit.

76- The system of claim 72, wherein the wall that the collector and combustor share in common is covered by ceramic tiles.

77- The system of claim 72, further including means for insulating the high temperature electrolysis unit so as to minimize heat loss.

78- The system of claim 76, further including means for insulating the combustor so as to minimize heat loss.

79- The system of claim 72, wherein the thickness of wall of the collector is tapered along its length.

80- The system of claim 72, further including means for supplying heat from external sources to the high temperature electrolysis section of the high temperature electrolysis unit.

81- The system of claim 72, further including means for separating the hydrogen gas and oxygen gas from the steam by way of electrodes.

82- The system of claim 72, further including means for transmitting the separated hydrogen gas from high temperature electrolysis unit to the corresponding compressor unit and to be stored in a pressurized tank.

83- The system of claim 72, further including means of removal gases other than hydrogen and oxygen generated by the high temperature electrolysis process.

84- A high temperature electrolysis unit comprising of an evaporation chamber section and a high temperature electrolysis section.

85- The system of claim 84, further including means for minimizing the corrosion of any part that is in contact with salts and minerals.

86- The system of claim 84, further including means for continuously removing the salts, minerals, metals and other contaminants from the evaporation chamber section.

87- The system of claim 84, further including means for insulating the high temperature electrolysis unit so as to minimize heat loss.

88- The system of claim 84, further including means for supplying heat from external sources to the high temperature electrolysis section of the high temperature electrolysis unit.

89- The system of claim 84, further including means for separating the hydrogen gas and oxygen gas from the steam by way of electrodes.

90- The system of claim 84, further including means for transmitting the separated hydrogen gas from high temperature electrolysis unit to the corresponding compressor unit and to be stored in a pressurized tank.

91- The system of claim 84, further including means of removal gases other than hydrogen and oxygen generated by the high temperature electrolysis process.
